(19) United States
(12) Patent Application Publication
(10) Pub. No.: US 2011/0062892 A1
(43) Pub. Date: Mar. 17, 2011

(54) DRIVING DEVICE FOR A LIGHT EMITTING DIODE CIRCUIT AND RELATED LIGHTING DEVICE

(76) Inventors: Jian-Shen Li, Taipei County (TW); Chia-Chieh Hung, Taoyuan County (TW); Shih-Min Chen, Hsinchu County (TW); Chun-Liang Lin, Taichung City (TW)

(21) Appl. No.: 12/561,260

(22) Filed: Sep. 16, 2009

(51) Int. Cl. H05B 41/36

(52) U.S. Cl. 315/307

(57) ABSTRACT

A driving device for an LED circuit includes a power receiving terminal, a capacitor, and a light adjusting unit. The power receiving terminal is coupled to a switch for receiving a DC power source that supplies for the LED circuit and the driving device via the switch. The capacitor is coupled to the power receiving terminal, and is utilized for storing energy. The light adjusting unit is coupled to the power receiving terminal and the capacitor, and is utilized for generating a control signal according the status of the switch when a voltage on the capacitor decreases and does not decrease below a first threshold voltage, for adjusting light intensity of the LED circuit.

### BACKGROUND OF THE INVENTION

1. Field of the Invention

The present invention relates to a driving device for a light emitting diode circuit and related lighting device, and more particularly, to a driving device capable of adjusting light intensity and related lighting device.

2. Description of the Prior Art

Lighting devices, such as bulbs or fluorescent lamps, are common used in a modern life. A user always switches between different light intensity of a lighting device for a required condition as dinning or reading. Light emitting diodes (LEDs), which provide high intensity and lower power consumption than traditional lighting devices as bulbs, are used in many applications, such as indicator lights or flashlights.

Please refer to FIG. 1, which is a functional block diagram of an LED lighting device 10 according to the prior art. The lighting device 10 includes an LED circuit 100, a microcontroller 102 and a pulse width modulation (PWM) control unit 104, which is used for adjusting multiple level of light intensity and is powered by a power source VCC. The microcontroller 102 generates a control signal V_{CTRL} corresponding to a specific intensity level, and outputs the control signal V_{CTRL} to the PWM control unit 104. The PWM control unit 104 generates a pulse signal V_{PWM} according to the control signal V_{CTRL} for controlling the current through the LED circuit 100, so as to adjust light intensity of the lighting device 10.

Briefly, light intensity of the lighting device 10 is controlled by the microcontroller 102. However, it is not easy for a user to adjust light intensity of the lighting device 10 as to adjust light intensity of a fluorescent lamp device through a switch. Also, it costs a lot to implement the microcontroller 102. So far the LED lighting device cannot replace the traditional lighting device.

### SUMMARY OF THE INVENTION

It is therefore a primary objective of the claimed invention to provide a driving device for an LED circuit and related lighting device.

The present invention discloses a driving device for an LED circuit. The driving device includes a power receiving terminal, a capacitor, and a light adjusting unit. The power receiving terminal is coupled to a switch for receiving a DC power source that supplies for the LED circuit and the driving device via the switch. The capacitor is coupled to the power receiving terminal, and is utilized for storing energy. The light adjusting unit is coupled to the power receiving terminal and the capacitor, and is utilized for generating a control signal according the status of the switch when a voltage on the capacitor decreases and does not decrease below a first threshold voltage, for adjusting light intensity of the LED circuit.

The present invention further discloses a lighting device including an LED circuit, a switch, and a driving device. The switch is coupled to an AC power source that supplies for the light device, and is utilized for controlling an output status of the AC power source. The driving device includes a power receiving terminal, a capacitor, a control unit, and a light adjusting unit. The power receiving terminal is coupled to the switch for receiving a DC power source converted from the AC power source via the switch. The capacitor is coupled to the power receiving terminal, and is utilized for storing energy. The control unit is coupled to the LED circuit, and is utilized for adjusting current consumption of the LED circuit according to a control signal, for driving the LED circuit. The light adjusting unit is coupled to the power receiving terminal, the capacitor, and the control unit, and is utilized for generating the control signal according the status of the switch when a voltage on the capacitor decreases and does not decrease below a first threshold voltage, for adjusting light intensity of the LED circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an LED lighting device according to the prior art.

FIG. 2 is a functional block diagram of a lighting device according to an embodiment of the present invention.

FIG. 3 and FIG. 4 are waveforms illustrating the voltage detected by the detecting unit in FIG. 2 and a detecting signal generated by the detecting unit.

FIG. 5 is a functional block diagram of a lighting device according to an embodiment of the present invention.

FIG. 6 and FIG. 7 are waveforms illustrating the voltage detected by the detecting unit in FIG. 5 and a detecting signal generated by the detecting unit.

FIG. 8 is a functional block diagram of a lighting device according to an embodiment of the present invention.

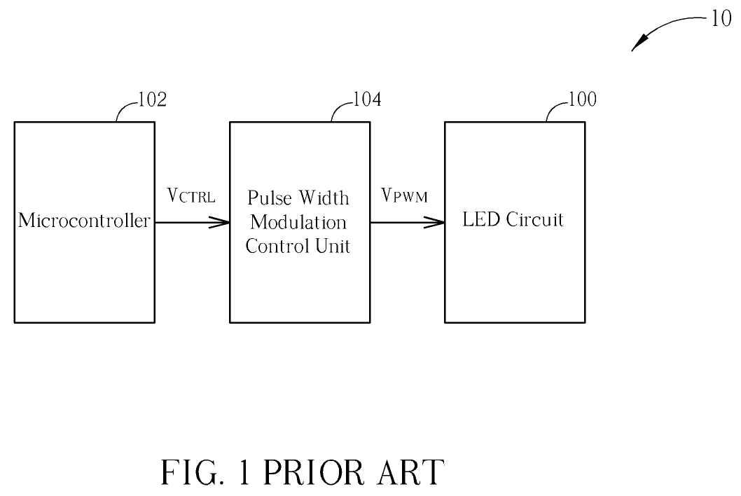

### DETAILED DESCRIPTION

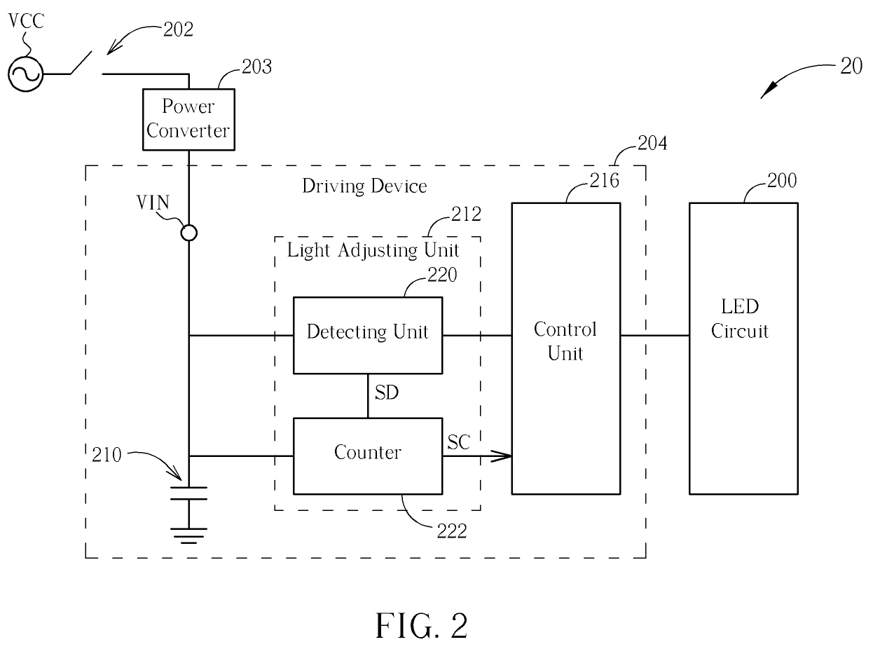

Please refer to FIG. 2, which is a functional block diagram of a lighting device 20 according to an embodiment of the present invention. The lighting device 20 is an LED lighting device, and the required power is provided by an alternating current (AC) power source VCC. The lighting device 20 comprises an LED circuit 200, a switch 202, a power converter 203, and a driving device 204. The LED circuit 200 includes multiple LEDs in series or in parallel. The switch 202 is coupled between the AC power source VCC and the power converter 203, and is utilized for controlling whether the AC power source VCC is outputted to the power converter 203. The power converter 203 is utilized for converting the AC power source VCC into a direct current (DC) power source that is used for the LED circuit 200 and the driving device 204. The driving device 204 is coupled to the LED circuit 200 and the power converter 203, and is utilized for driving the LED circuit 200 and adjusting light intensity of the LED circuit 200, which is described in detail as follows.

The driving device 204 comprises a power receiving terminal VIN coupled to the power converter 203, a capacitor 210, a light adjusting unit 212, and a control unit 216. When the switch 202 is turned on, the power receiving terminal VIN receives DC power source generated by the power converter 203. The capacitor 210 is coupled to the power receiving terminal VIN, and is utilized for storing energy. The light adjusting unit 212 is coupled to the power receiving terminal VIN, the capacitor 210, and the control unit 216, and is utilized for generating a control signal SC that is outputted to the control unit 216 according to on/off states of the switch 202 when a voltage on the capacitor 210 decreases and does not decrease below a threshold voltage VTH1, which is a minimal operation voltage of the adjusting unit 212. The control unit 216 is coupled to the light adjusting unit 212 and the LED circuit 200, and is utilized for adjusting an operating current of the LED circuit 200 according to the control signal SC, or adjusting a number of lightened LEDs, so as to drive the LED circuit 200 to generate the light of different light intensity, e.g. full light, dim light, etc. The control unit 216 can be implemented in different circuitry and is not restricted in the embodiment of the present invention.

Note that, the driving device 204 implements multilevel light intensity adjustment. The light adjusting unit 212 comprises a detecting unit 220 and a counter 222. The detecting unit 220 is coupled to the power receiving terminal VIN and the capacitor 210, and is utilized for generating a detecting signal SD according to on/off state of the switch 202 when the voltage of the capacitor 210 decreases and does not decrease below the threshold voltage VTH1. When the switch 202 is turned off, the voltage on the power receiving terminal VIN start decreasing. When the detecting unit 220 detects that the voltage on the power receiving terminal VIN decreases below a threshold voltage VTH2, the voltage level of the detecting signal SD converts, such as from a high voltage level to a low voltage level.

The counter 222 is coupled to the detecting unit 220, the capacitor 210, and the control unit 216, and is utilized for counting the number of times of the detecting signal SD converting from the high voltage level to the low voltage level when the switch 202 is turned off and the voltage on the capacitor 210 does not decrease below the threshold voltage VTH1, for generating the corresponding control signal SC. During the counter 222 counts the number of times of the detecting signal SD converting from the high voltage level to the low voltage level, the power source that the counter 222 requires comes from the energy stored in the capacitor 210. For example, when the switch 202 is turned on and off by three times before the voltage on the capacitor 210 decreases below the threshold voltage VTH1, the detecting signal SD is affected and converts from the high voltage level to the low voltage level for three times, which is counted by the counter 222. The counter 222 generates the control signal SC corresponding to three times of voltage level converting from high to low, which controls the LED circuit 200 to generate a dim light.

The detecting unit 220 is a voltage detector whose reference voltage as the threshold voltage VTH2, for example. When the detecting unit 220 detects a voltage higher than the threshold voltage VTH2, the detecting signal SD outputted by the detecting unit 220 is at a high voltage level, and when the detecting unit 220 detects a voltage lower than the threshold voltage VTH2, the detecting signal SD is at a low voltage level. In the driving device 204, the operation voltage of the detecting unit 220 and the operation voltage of the counter 222 are set different for preventing the condition that the detecting unit 220 outputs the detecting signal SD by a wrong voltage level when the switch 202 is turned off due to the voltage on the capacitor 210.

When the switch 202 is turned off, the power converter 203 does not output DC power source to the light adjusting unit 212; meanwhile, the power sources which the detecting unit 220 and the counter 222 require are supplied by energy stored in the capacitor 210. During the time when the voltage on the capacitor 210 decreases but does not decrease below the threshold voltage VTH1, each time the switch 202 is turned off, the detecting signal SD is turned from a high voltage level to a low voltage level. The counter 222 counts how many times the detecting signal SD is turned from the high voltage level to the low voltage level, and outputs the control signal SC corresponding to the counted times. Therefore, when the switch 202 is turned on, the control unit 216 controls the operation current of the LED circuit 200 according to the control signal SC, so that the LED circuit 200 are lightened with the desired light intensity.

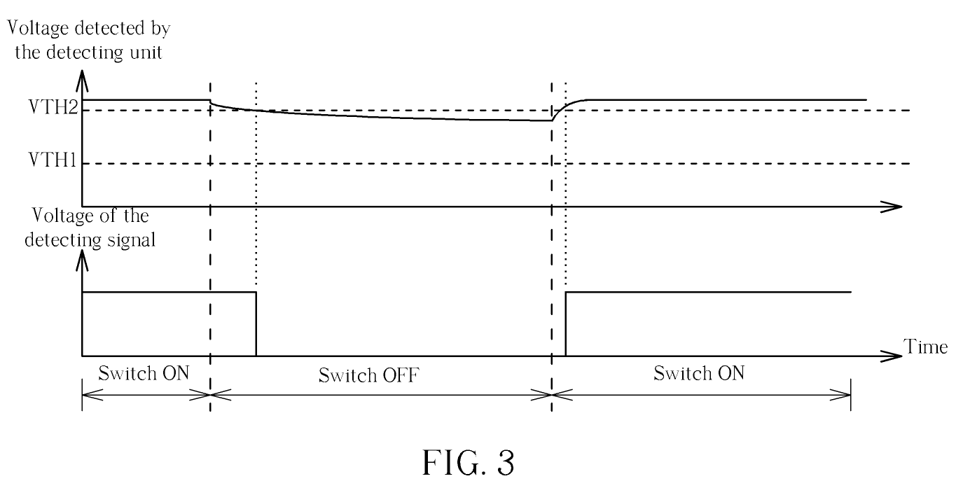

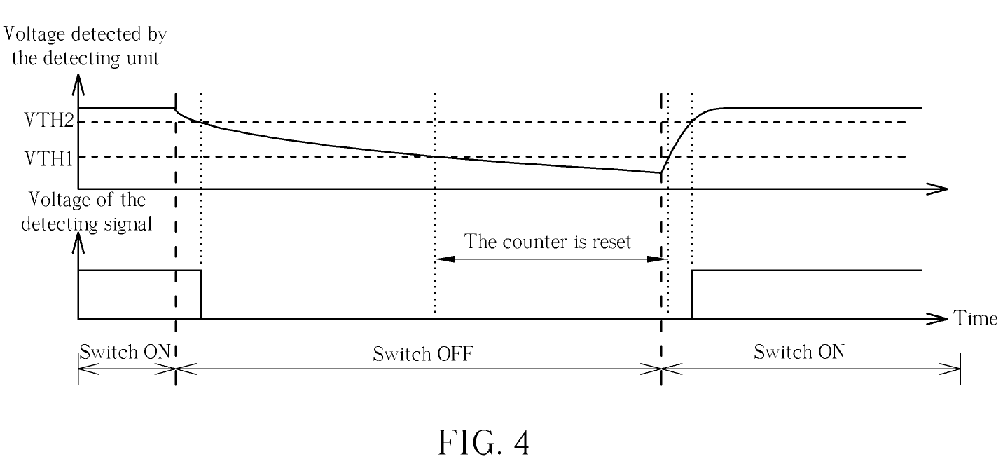

Please refer to FIG. 3 and FIG. 4, which illustrate relationship between the voltage detected by the detecting unit 220 in FIG. 2 and the detecting signal SD. Note that in FIG. 2, the detecting unit 220 detects the voltage on the capacitor 210. The threshold voltage VTH1 is the minimal operation voltage of the light adjusting unit 212 and is also the reset voltage of the counter 222; the threshold voltage VTH2 is the reference voltage of the detecting unit 220. As shown in FIG. 3, when the voltage detected by the detecting unit 220 decreases below the threshold voltage VTH2 (but does not decrease below the threshold voltage VTH1 yet), the detecting signal SD is turned from the high voltage level to the low voltage level. When the voltage detected by the detecting unit 220 rises over the threshold voltage VTH2, the detecting signal SD is turned from the low voltage level to the high voltage level again. As shown in FIG. 4, when the voltage detected by the detecting unit 220 decreases below the threshold VTH1, the counter 222 is reset, which means that the control signal SC is reset to an initial value that leads to a default light intensity.

As mentioned previously, a conventional lighting device uses an expensive microcontroller to adjust light intensity of an LED circuit. In comparison, in the lighting device 20, the present invention uses low-cost and simple components, such as a voltage detector and a counter, to implement the similar light intensity adjustment. Therefore, cost of the lighting device 20 is reduced. The present invention also uses a capacitor for storing energy and supplying power source for the counter 222 when the switch 202 is turned off, so that the light intensity adjustment can be operated successfully. The driving device 204, except the capacitor 210, is usually implemented into an LED driver IC, and the capacitor 210 is off chip.

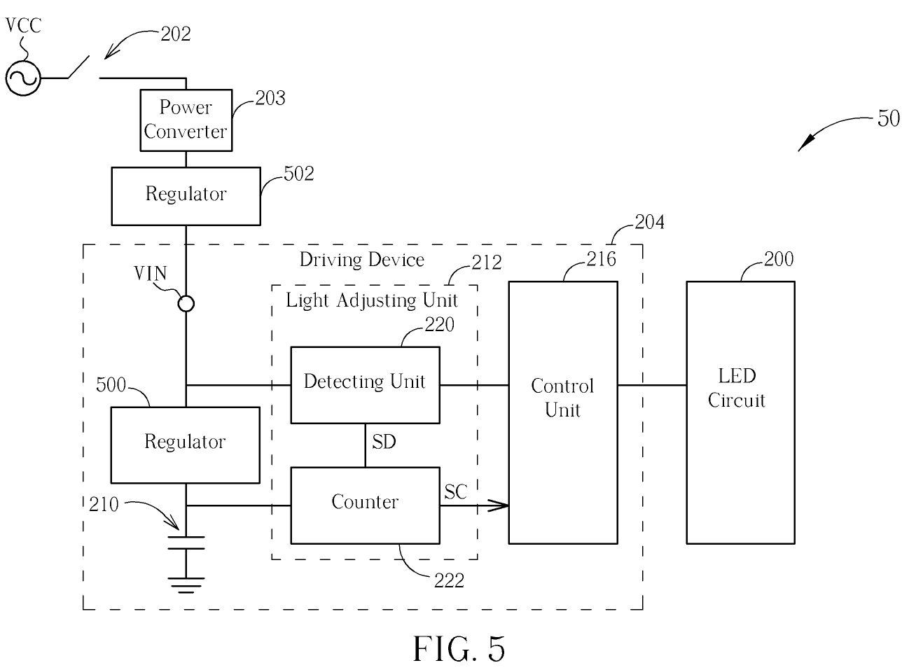

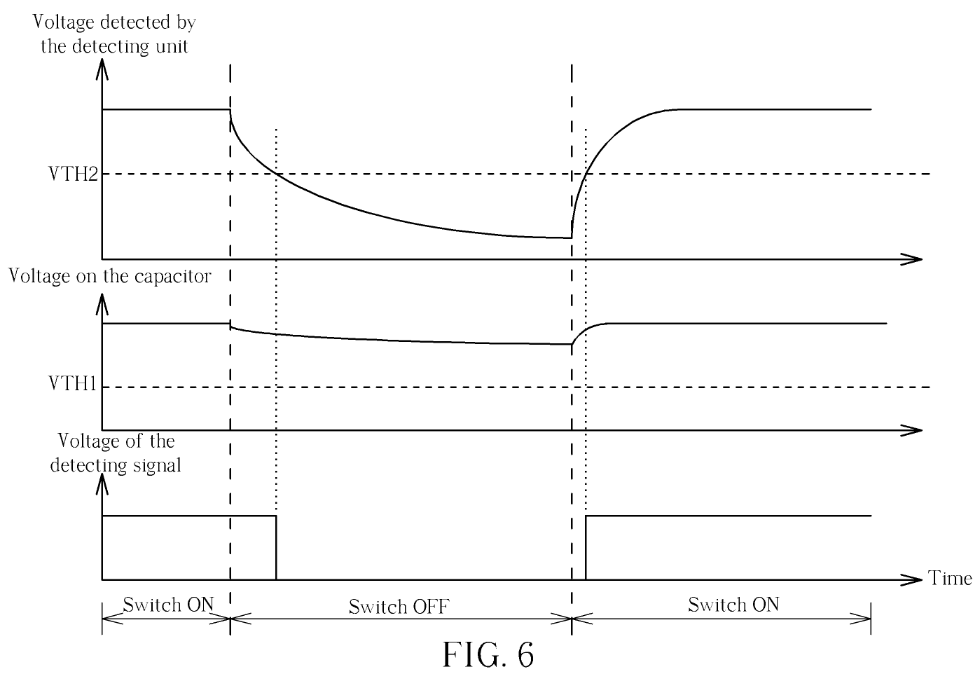

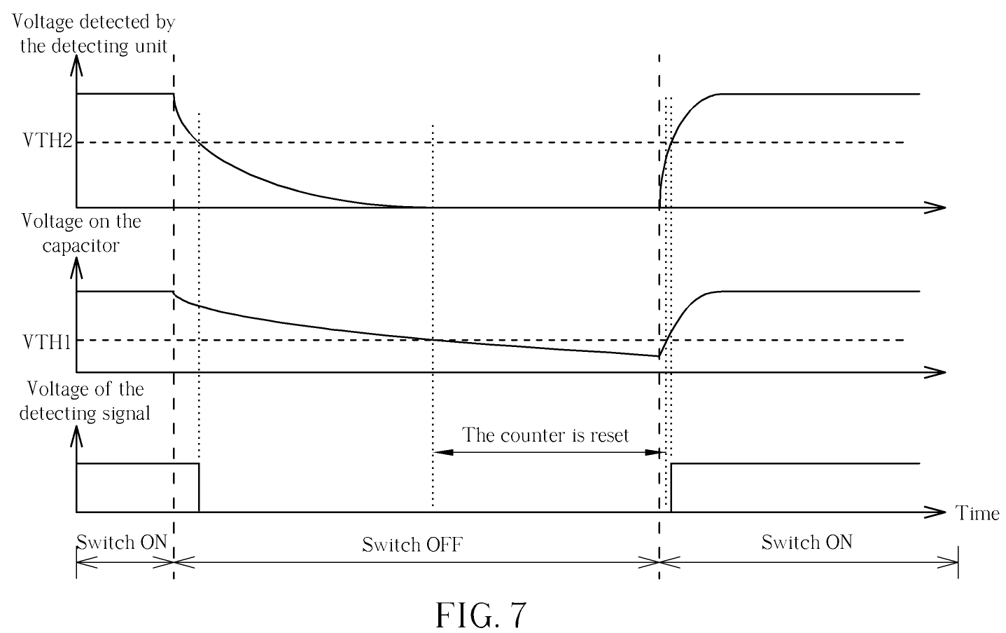

The present invention further provides an embodiment for solving issues that the energy stored in the capacitor 210 has a limit, and the output voltage of the power converter 203 may be higher than a maximal operation voltage of the light adjusting unit 212. Please refer to FIG. 5, which is a functional block diagram of a lighting device 50 according to an embodiment of the present invention. Similar to the lighting device 20 in FIG. 2, the lighting device 50 comprises the LED circuit 200, the switch 202, the power converter 203, the driving device 204, and further comprises a regulator 500, and a regulator 502. The regulator 500 is coupled between the power receiving terminal VIN and the counter 222, and is used as a single directional component. By the use of the regulator 500, the energy stored in the capacitor 210 are only used for the counter 222 when the switch 202 is turned off, and thereby the counter 222 cannot be reset soon. In another embodiment of the present invention, the regulator 500 is replaced by another single directional component, such as a diode, or a transistor. The regulator 502 is coupled between the power converter 203 and the power receiving terminal VIN, and is utilized for converting the voltage outputted by the power converter 203 into a voltage that is appropriate to be the operation voltage of the light adjusting unit 212. Please refer to FIG. 6 and FIG. 7, which illustrate relationship between the voltage detected by the detecting unit 220 in FIG. 5 and the detecting signal SD. Note that, the voltage detected by the detecting unit 220 in FIG. 5 is different from the voltage on the capacitor 210.

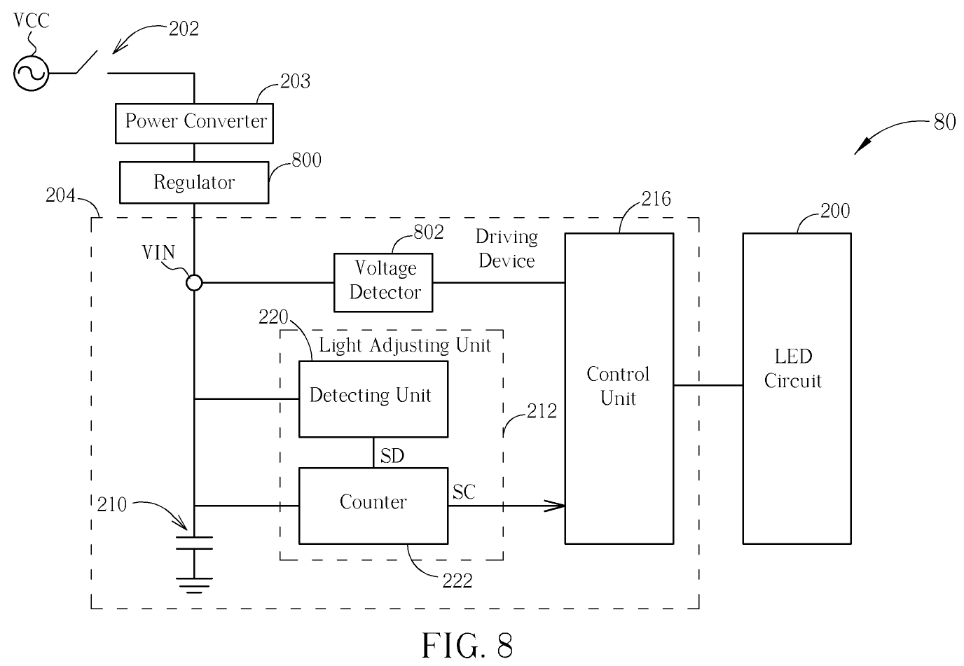

In the lighting device 20, the operation voltage of the counter 222 is assumed to be the same as the operation voltage of the control unit 216, and the power sources of the counter 222 and the control unit 216 are both provided via the detecting unit 220. In this situation, the use of the energy stored in the capacitor 210 is not optimized. Please refer to FIG. 8, which is a functional block diagram of a lighting device 80 according to an embodiment of the present invention. The lighting device 80 comprises not only all of units in the lighting device 20 but also comprises a regulator 800 and a voltage detector 802. The regulator 800 is coupled between the power converter and the power receiving terminal VIN, and is utilized for converting the voltage outputted by the power converter 203 into another voltage appropriate to be the operation voltage of the light adjusting unit 212. The voltage detector 802 is coupled between the power receiving terminal VIN and the control unit 216, and the operation voltage of the voltage detector 802 is higher than the detecting unit 220 and the counter 222. When the voltage on the power receiving terminal VIN is higher than a reference voltage of the voltage detector 802, the voltage detector 802 outputs a DC power source to the control unit 216, wherein the voltage of the DC power source is equal to the voltage on the power receiving terminal VIN. Therefore, when the switch 202 is turned off and the voltage on the power receiving terminal VIN decreases, the voltage detector 802 is turned off earlier, and the energy stored in the capacitor 210 only provides for the counter 222. As in FIG. 8, energy stored in the capacitor 210 is used efficiently without a single directional component.

The lighting device 20, 50, and 80 are embodiments of the present invention, and those skilled in the art can make alterations and modifications accordingly. The single directional component, the regulator, or the voltage detector can be added or removed depends on requirement. In the lighting devices 20, 50, and 80, the counter 222 receives the detecting signal SD and a power source via the detecting unit 220; the detecting unit 220 receives a power source generated by the power converter 203, and detects whether the switch 202 is turned off according to the power source. In another embodiment, the counter 222 can receive a signal generated according to an AC power source behind the switch 202 as a detecting signal instead of the detecting signal SD outputted by the detecting unit 220. Besides, the detecting unit 220 can be coupled to anyplace between the switch 202 and the power receiving terminal VIN, to detect whether the switch is turned off through the AC power source or the DC power source.

In conclusion, the present invention uses simple circuitry including the detecting unit and the counter to implement light adjusting function. The present invention uses a capacitor to store energy and maintains operation of the counter when the switch is turned off. Besides, the present invention uses a single directional component, a regulator, or a voltage detector to avoid that the energy stored in the capacitor is wasted soon. Therefore, the counter is not reset frequently, and convenience for adjusting light intensity is improved.

Those skilled in the art will readily observe that numerous modifications and alterations of the device and method may be made while retaining the teachings of the invention.

What is claimed is:

1. A driving device for a light emitting diode (LED) circuit comprising:
a power receiving terminal coupled to a switch for receiving a direct current (DC) power source that supplies for the LED circuit and the driving device via the switch;
a capacitor coupled to the power receiving terminal for storing energy; and
a light adjusting unit coupled to the power receiving terminal and the capacitor for generating a control signal according the status of the switch when a voltage on the capacitor decreases and does not decrease below a first threshold voltage, for adjusting light intensity of the LED circuit.

2. The driving device of claim 1, wherein the light adjusting unit comprises:
a detecting unit coupled to the power receiving terminal and the capacitor for generating a detecting signal according the status of the switch when the voltage on the capacitor decreases and does not decrease below the first threshold voltage; and
a counter coupled to the detecting unit and the capacitor for generating the control signal according to the detecting signal.

3. The driving device of claim 2, wherein the detecting unit generates the detecting signal when the voltage on the capacitor decreases and does not decrease below the first threshold voltage and the voltage detected by the detecting unit decreases below a second threshold voltage.

4. The driving device of claim 2, wherein the counter is reset when the voltage on the capacitor decreases below the first threshold voltage.

5. The driving device of claim 1, wherein the first threshold voltage is a minimal operation voltage of the light adjusting unit.

6. The driving device of claim 1 further comprising a control unit coupled between the light adjusting unit and the LED circuit, for adjusting current consumption of the LED circuit according to the control signal in order to drive the LED circuit.

7. The driving device of claim 6 further comprising a voltage detector coupled between the power receiving terminal and the control unit, for outputting the DC power source to the control unit when a voltage on the power receiving terminal is higher than a reference voltage of the voltage detector.

8. The driving device of claim 1 further comprising a regulator coupled between the DC power source and the power receiving terminal, for generating an operation voltage of the light adjusting unit.

9. The driving device of claim 1 further comprising a single directional component coupled between the power receiving terminal and the light adjusting unit.

10. The driving device of claim 9, wherein the single directional component is a regulator or a diode.

11. A lighting device comprising:
a light emitting diode (LED) circuit comprising at least one LED;
a switch coupled to an alternating current (AC) power source supplying for the light device, for controlling an output status of the AC power source; and
a driving device comprising:
a power receiving terminal coupled to the switch for receiving a direct current (DC) power source converted by the AC power source via the switch;
a capacitor coupled to the power receiving terminal for storing energy;
a control unit coupled to the LED circuit for adjusting current consumption of the LED circuit according to a control signal, for driving the LED circuit; and
a light adjusting unit coupled to the power receiving terminal, the capacitor, and the control unit, for generating the control signal according the status of the switch when a voltage on the capacitor decreases and does not decrease below a first threshold voltage, for adjusting light intensity of the LED circuit.

12. The lighting device of claim 11, wherein the light adjusting unit comprises:
a detecting unit coupled to the power receiving terminal and the capacitor for generating a detecting signal according the status of the switch when the voltage on the capacitor decreases and does not decrease below the first threshold voltage; and
a counter coupled to the detecting unit and the capacitor for generating the control signal according to the detecting signal.

13. The lighting device of claim 12, wherein the detecting unit generates the detecting signal when the voltage on the capacitor decreases and does not decrease below the first threshold voltage and the voltage detected by the detecting unit decreases below a second threshold voltage.

14. The lighting device of claim 12, wherein the counter is reset when the voltage on the capacitor decreases below the first threshold voltage.

15. The lighting device of claim 11, wherein the first threshold voltage is a minimal operation voltage of the light adjusting unit.

16. The lighting device of claim 11 further comprising a voltage detector coupled between the power receiving terminal and the control unit, for outputting the DC power source to the control unit when a voltage on the power receiving terminal is higher than a reference voltage of the voltage detector.

17. The lighting device of claim 11 further comprising a regulator coupled between the DC power source and the power receiving terminal, for generating an operation voltage of the light adjusting unit.

18. The lighting device of claim 11 further comprising a single directional component coupled between the power receiving terminal and the light adjusting unit.

19. The lighting device of claim 18, wherein the single directional component is a regulator or a diode.
